(19) United States
(12) Patent Application Publication
(10) Pub. No.: US 2004/0014834 A1
(43) Pub. Date: Jan. 22, 2004

(54) Light scattering reflection substrate-use photosensitive resin composition, light scattering reflection substrate, and production methods therefor

(76) Inventors: Satoshi Shiiki, Osaka (JP); Toru Takashima, Osaka (JP); Etsuo Ogino, Osaka (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/363,442

(22) PCT Filed: Jun. 20, 2002
(86) PCT No.: PCT/JP02/06145

(30) Foreign Application Priority Data
Jun. 29, 2001 (JP) 2001198382
Aug. 10, 2001 (JP) 2001243844

(51) Int. Cl. C08F 2/46

(52) U.S. Cl. 522/71; 428/221

(57) ABSTRACT

A first object of the present invention is to provide a light-scattering/reflecting substrate according to which adhesion between a light-scattering film and a reflecting film can be improved, and durability and chemical resistance can be improved. A light-scattering/reflecting substrate 1 is comprised of a soda lime silicate glass substrate 2, a light-scattering film 3 that has an undulating shape and is formed on the glass substrate 2, and a reflecting film 4 that is formed on the light-scattering film 3 following the undulating shape of the light-scattering film 3. The light-scattering film 3 is formed into the desired undulating shape by applying, onto a surface of the glass substrate 2, a material obtained by adding a photosensitive resin made of an organic material as a binder to an inorganic material such as silicon oxide (silica), aluminum oxide (alumina) or titanium oxide (titania), and then using a photolithography method.

### TECHNICAL FIELD

The present invention relates to a photosensitive resin composition for light-scattering/reflecting substrates, and a light-scattering/reflecting substrate and a manufacturing method thereof, and in particular to a photosensitive resin composition for light-scattering/reflecting substrates, and a light-scattering/reflecting substrate and a manufacturing method thereof that are suitable for use with liquid crystal displays (LCDs) and the like.

### BACKGROUND ART

Conventionally, in liquid crystal displays (LCDs) and the like, a light-scattering/reflecting substrate in which a light-scattering film made of an organic material is formed in an undulating shape on a surface of a glass substrate is used. Such a light-scattering/reflecting substrate has generally been manufactured through a photolithography method in which light is shone onto predetermined parts of an acrylic type photosensitive resin using a photomask to cure these predetermined parts, and then uncured parts are washed away, thus forming an undulating shape (see, for example, Japanese Laid-open Patent Publication (Kokai) No. 2001-13495).

Most photosensitive resins used as the light-scattering film in the case of such a photolithography method have an organic material as a principal component thereof, although there have been cases in which an inorganic material is partially added with an objective of changing the physical properties (see, for example, Japanese Laid-open Patent Publication (Kokai) No. 11-327125).

However, in the case of a conventional light-scattering/reflecting substrate as described above, the light-scattering film itself is constituted from a 100% organic material, and thus the chemical properties, the coefficient of thermal expansion and so on differ to those of a reflecting film that is deposited on the light-scattering film and is made of an inorganic material; consequently, there is a problem that adhesion between the light-scattering film and the reflecting film is poor, and hence the reflecting film readily peels off. Moreover, there is a problem that a light-scattering film made of an organic material discharges adsorbed components in the organic material and unreacted components inside the organic material as a gas, resulting in degradation of the reflecting film.

Furthermore, an organic material does not give a sufficient margin with regard to the durability and chemical resistance required of an LCD; because an organic material has a low glass transition temperature (Tg) or decomposition temperature, heat treatment of the substrate cannot be carried out during the step of depositing the reflecting film, and a vacuum deposition method or the like in which the substrate temperature is raised to 300° C. cannot be used, and hence there is a problem that the scope of selection of the manufacturing method is limited.

It is a first object of the present invention to provide a photosensitive resin composition for light-scattering/reflecting substrates, and a light-scattering/reflecting substrate and a manufacturing method thereof, according to which adhesion between a light-scattering film and a reflecting film can be improved, and durability and chemical resistance can be improved.

Moreover, it is a second object of the present invention to provide a photosensitive resin composition for light-scattering/reflecting substrates, and a light-scattering/reflecting substrate and a manufacturing method thereof, according to which heat resistance can be increased, and adhesion of a reflecting film can be improved.

### DISCLOSURE OF THE INVENTION

To attain the above first object, in a first aspect of the present invention, there is provided a light-scattering/reflecting substrate comprising a substrate, a light-scattering film having (an undulating shape and formed on the substrate, and a reflecting film formed on the light-scattering film, the light-scattering/reflecting substrate being characterized in that the light-scattering film has an inorganic material as a principal component thereof.

Moreover, in the light-scattering/reflecting substrate according to the first aspect, it is preferable for the inorganic material to be made of a metal oxide.

To attain the above first object, in a second aspect of the present invention, there is provided a method of manufacturing a light-scattering/reflecting substrate, comprising a light-scattering film formation step of forming a light-scattering film on a substrate, and a reflecting film formation step of forming a reflecting film on the light-scattering film, the method being characterized in that the light-scattering film has an inorganic material as a principal component thereof, and in the light-scattering film formation step, the light-scattering film is formed into a desired undulating shape through a photolithography method.

To attain the above first object, in a third aspect of the present invention, there is provided a method of manufacturing a light-scattering/reflecting substrate, comprising a light-scattering film formation step of forming a light-scattering film on a substrate, and a reflecting film formation step of forming a reflecting film on the light-scattering film, the method being characterized in that the light-scattering film has an inorganic material as a principal component thereof, and in the light-scattering film formation step, the light-scattering film is formed into a desired undulating shape through a transfer method using a die.

To attain the above first object, in a fourth aspect of the present invention, there is provided a method of manufacturing a light-scattering/reflecting substrate, comprising a light-scattering film formation step of forming a light-scattering film on a substrate, and a reflecting film formation step of forming a reflecting film on the light-scattering film, the method being characterized in that the light-scattering film has an inorganic material as a principal component thereof, and in the light-scattering film formation step, the light-scattering film is formed into a desired undulating shape by including fine particles inside the light-scattering film.

Moreover, in the method of manufacturing a light-scattering/reflecting substrate according to the fourth aspect, it is preferable for the fine particles to be made of an inorganic material.

To attain the above second object, in a fifth aspect of the present invention, there is provided a photosensitive resin composition for light-scattering/reflecting substrates, characterized by comprising a photosensitive resin and inorganic fine particles.

Moreover, in the photosensitive resin composition for light-scattering/reflecting substrates according to the fifth aspect, it is preferable for the inorganic fine particles to have a mean particle diameter in a range of 1 to 100 nm.

Moreover, in the photosensitive resin composition for light-scattering/reflecting substrates according to the fifth aspect, it is preferable for the inorganic fine particles to be colloidal silica.

Moreover, in the photosensitive resin composition for light-scattering/reflecting substrates according to the fifth aspect, it is preferable for the photosensitive resin composition to be able to be developed using water or an alkaline aqueous solution.

Moreover, in the photosensitive resin composition for light-scattering/reflecting substrates according to the fifth aspect, it is preferable for the photosensitive resin to contain a polyvinylphenol type resin having hydroxyl groups protected by at least one of alkoxyalkyl groups and alkoxycarbonyl groups, and a photoacid generator.

Moreover, in the photosensitive resin composition for light-scattering/reflecting substrates according to the fifth aspect, it is preferable for a proportion of the inorganic fine particles to be in a range of 100 to 5000 parts by weight per 100 parts by weight of the photosensitive resin in terms of solids.

Moreover, in the photosensitive resin composition for light-scattering/reflecting substrates according to the fifth aspect, it is preferable for the proportion of the inorganic fine particles to be in a range of 200 to 3000 parts by weight per 100 parts by weight of the photosensitive resin in terms of solids.

To attain the above second object, in a sixth aspect of the present invention, there is provided a light-scattering/reflecting substrate characterized by comprising a substrate, and a photosensitive layer made of the photosensitive resin composition according to the above fifth aspect of the present invention formed on the substrate.

To attain the above second object, in a seventh aspect of the present invention, there is provided a method of manufacturing a light-scattering/reflecting substrate, characterized by forming a photosensitive layer made of the photosensitive resin composition according to the above fifth aspect of the present invention on a substrate.

### BRIEF DESCRIPTION OF THE DRAWINGS

FIG. 1.is a sectional view schematically showing the structure of a light-scattering/reflecting substrate according to a first embodiment of the present invention.

FIG. 2 is a flowchart of a photolithography method of forming a light-scattering film 3 appearing in FIG. 1.

FIG. 3 is a sectional view schematically showing the structure of a light-scattering/reflecting substrate according to a second embodiment of the present invention.

FIG. 4 is a flowchart of a manufacturing process of the light-scattering/reflecting substrate 10 appearing in FIG. 3.

### BEST MODES FOR CARRYING OUT THE INVENTION

The present inventors carried out assiduous studies to attain the above first object, and as a result discovered that in the case of a light-scattering/reflecting substrate comprised of a substrate, a light-scattering film having an undulating shape and formed on the substrate, and a reflecting film formed on the light-scattering film, if the light-scattering film has an inorganic material as a principal component thereof, then adhesion between the light-scattering film and the reflecting film is improved, and durability and chemical resistance are improved.

Moreover, the present inventors discovered that in the case of a method of manufacturing a light-scattering/reflecting substrate comprised of a light-scattering film formation step of forming a light-scattering film on a substrate, and a reflecting film formation step of forming a reflecting film on the light-scattering film, if the light-scattering film has an inorganic material as a principal component thereof, and in the light-scattering film formation step, the light-scattering film is formed into a desired undulating shape through a photolithography method, or the light-scattering film is formed into a desired undulating shape through a transfer method using a die, or the light-scattering film is formed into a desired undulating shape by including fine particles inside the light-scattering film, then adhesion between the light-scattering film and the reflecting film is improved, and durability and chemical resistance are improved, and in addition the light-scattering film can easily be formed into the undulating shape.

Furthermore, the present inventors carried out assiduous studies to attain the above second object, and as a result discovered that if a photosensitive resin composition for light-scattering/reflecting substrates is constituted from a photosensitive resin and inorganic fine particles, then heat resistance can be increased, and adhesion of the reflecting film can be improved; preferably, the inorganic fine particles have a mean particle diameter in a range of 1 to 100 nm, in which case this mean particle diameter is less than an exposed light wavelength, i.e. the inorganic fine particles can reliably be made to be substantially transparent at the exposed light wavelength, and as a result good light-scattering characteristics can be obtained; moreover, if colloidal silica is used as the inorganic fine particles having such a mean particle diameter, then the inorganic fine particles can easily be procured, and good light-scattering characteristics can be obtained reliably.

Moreover, the present inventors discovered that in the case that the photosensitive resin composition for light-scattering/reflecting substrates can be developed using water or an alkaline aqueous solution, heat resistance can be increased reliably, and adhesion of the reflecting film can be improved reliably; preferably, the photosensitive resin contains a polyvinylphenol type resin having hydroxyl groups protected by alkoxyalkyl groups and/or alkoxycarbonyl groups, and a photoacid generator, in which case it can reliably be made to be such that the photosensitive resin composition for light-scattering/reflecting substrates can be developed using water or an alkaline aqueous solution, and moreover handling can be made easy.

Moreover, the present inventors discovered that if the proportion of the inorganic fine particles is in a range of 100 to 5000 parts by weight, preferably 200 to 3000 parts by weight, per 100 parts by weight of the photosensitive resin in terms of solids, then there is no impairment of sensitivity or pattern resolution. Moreover, the present inventors discovered that in the case that there is not more than 100 parts by weight of the inorganic fine particles, adhesion of the reflecting film, which is an effect of the present invention, drops, and in the case that there is not less than 5000 parts by weight of the inorganic fine particles, it becomes impossible to form a film of the photosensitive resin composition.

Moreover, the present inventors discovered that according to a light-scattering/reflecting substrate on which a photosensitive layer made of the above photosensitive resin composition is formed, heat resistance can be increased, and adhesion of the. reflecting film can be improved.

Moreover, the present inventors discovered that according to a method of manufacturing a light-scattering/reflecting substrate in which a photosensitive layer made of the above photosensitive resin composition is formed on a substrate, heat resistance can be increased, and adhesion of the reflecting film can be improved.

A description of light-scattering/reflecting substrates according to embodiments of the present invention will now be given with reference to the drawings.

First Embodiment

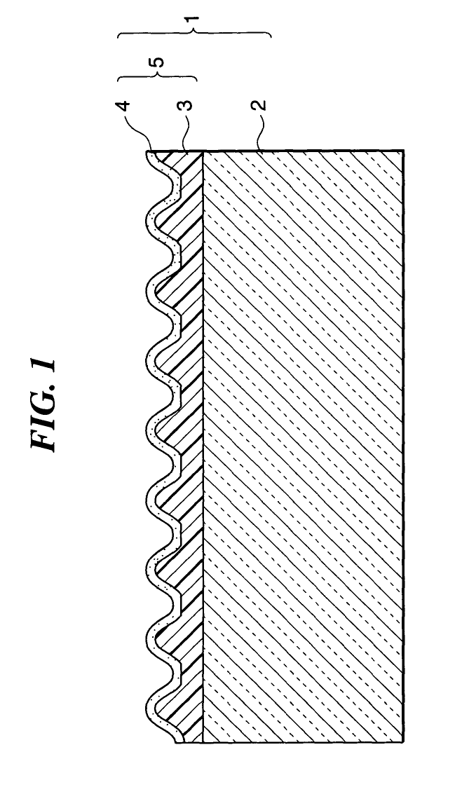

FIG. 1 is a sectional view schematically showing the structure of a light-scattering/reflecting substrate according to a first embodiment of the present invention.

In FIG. 1, a light-scattering/reflecting substrate 1 is comprised of a soda lime silicate glass substrate 2, a light-scattering film 3 that has an undulating surface and is formed on the glass substrate 2, and a reflecting film 4 that is deposited on the light-scattering film 3 following the undulating surface of the light-scattering film 3. The light-scattering film 3 and the reflecting film 4 constitute a light-scattering/reflecting film 5, and this light-scattering/reflecting film 5 has a function of diffusely reflecting light due to the undulating surface.

The light-scattering film 3 has an inorganic material as a principal component thereof. The inorganic material is preferably one that can be procured as particles; in particular, silicon oxide (silica), aluminum oxide (alumina), titanium oxide (titania) and the like have many varieties, and are easily procured, and hence are suitable.

Moreover, a very small amount of an organic component is added to the light-scattering film 3 as a binder (an adhesive) for binding inorganic components together. If one attempted to make the light-scattering film 3 from only an inorganic material such as silica, then it would be necessary to strongly bind the inorganic component of the glass substrate 2 and the inorganic component of the light-scattering film 3 together to maintain the undulating shape possessed by the light-scattering film 3, and in this case it would be necessary to carry out high-temperature treatment through sintering. As a result, the smoothness of the glass substrate 2 itself would be lost, and hence to avoid this a very small amount of an organic compound is added as a binder to the inorganic material.

As the organic compound, it is preferable to use a material that is capable of binding the inorganic components together, and that is easily procured; a photosensitive resin is suitable, since in this case it is easy to form the light-scattering film 3 into an undulating shape. As photosensitive resins, there are negative type resins and positive type resins, and either can be used. For example, as a positive type resin, a polyvinylphenol type resin or the like is preferable, and as a negative type resin, a styrylpyridine type resin or the like is preferable.

As the reflecting film 4, a thin metal film having a reflectance of not less than 50% is used. The material of the thin metal film is selected from aluminum (Al), silver (Ag), and alloys having these metals as a principal component thereof; the thin metal film may be a single layer, or may be a plurality of layers made of a plurality of types of metal. Moreover, to increase the reflectance of the reflecting film 4, a reflection-increasing layer made of a dielectric substance may be added to the thin metal film.

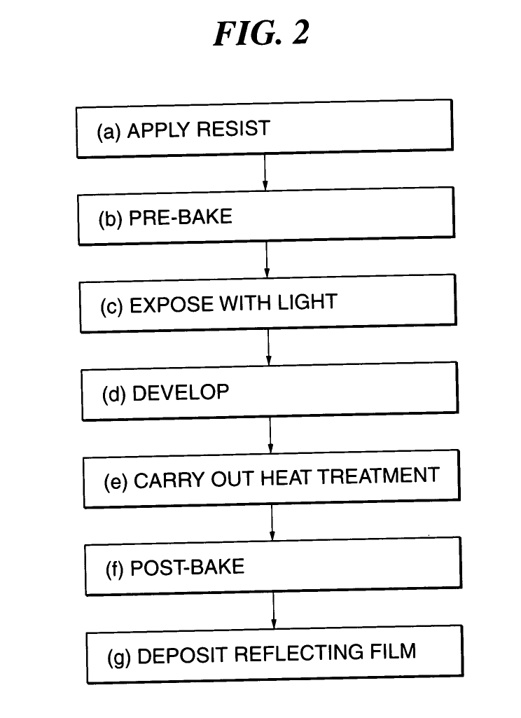

To form the surface of the light-scattering film 3 into the desired undulating shape, the light-scattering film 3 is preferably formed through a photolithography method. As shown in FIG. 2, the photolithography method is comprised of the steps of (a) applying a resist, (b) pre-baking, (c) exposing with light, (d) developing, (e) carrying out heat treatment, (f) post-baking, and (g) depositing the reflecting film.

In the resist application step, the photosensitive resin having the inorganic material as a principal component thereof is applied onto a surface of the glass substrate 1 by spin coating, and in the pre-baking step, the glass substrate 1 on which the photosensitive resin has been applied is pre-baked using a hot plate. Next, in the exposure step, the photosensitive resin is exposed with light using a photomask, and in the developing step, the surface of the photosensitive resin that has been exposed with light is developed using a developing liquid. In the heat treatment step, thermal melting (reflow) is carried out to an extent such that the undulating shape of the photosensitive resin surface does not change greatly, and in the post-baking step, the whole is heated to cure the resin, thus forming the undulating shape of the light-scattering film 3. Furthermore, in the reflecting film deposition, a reflecting film 4 made of an inorganic material such as a metal or a dielectric substance is deposited on the light-scattering film 3 using a sputtering method, a vacuum deposition method or the like, thus manufacturing the light-scattering/reflecting substrate 1.

Moreover, as a method of forming the light-scattering film 3, a method may also be used in which the photosensitive resin having the inorganic material as a principal component thereof is applied onto the glass substrate 2, the desired undulating shape is formed on the surface of the photosensitive resin through a transfer method using a die, and then heat-curing or light-curing is carried out.

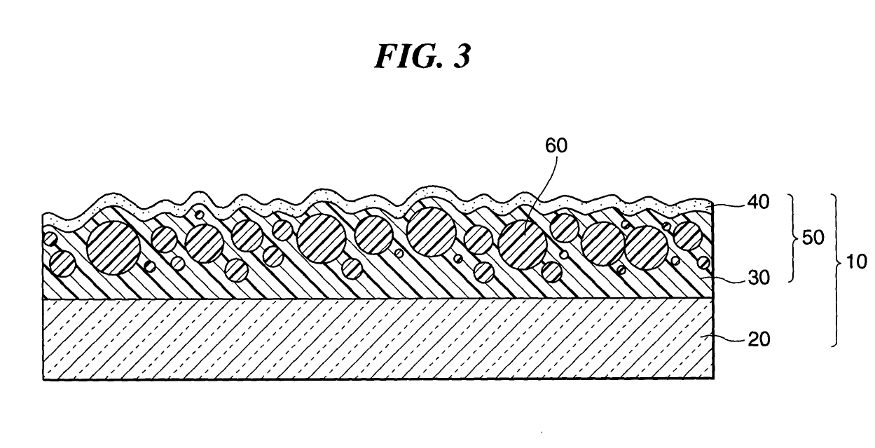

Furthermore, as another method of forming the light-scattering film 3, a method may also be used in which a photosensitive resin having fine particles made of an inorganic material included therein is applied onto the glass substrate 2, and then curing is carried out through drying and baking steps. A sectional view of a light-scattering/reflecting substrate 1 manufactured through this method is shown in FIG. 3.

In the first embodiment described above, a photosensitive resin was given as an example of the binder component, but a thermosetting resin may also be used as the binder component. In this case, the undulating shape of the light-scattering film 3 may be formed through a method in which the thermosetting resin is cured in places by infrared rays or electromagnetic induction heating, and then the uncured parts are removed.

Second Embodiment

FIG. 3 is a sectional view schematically showing the structure of a light-scattering/reflecting substrate according to a second embodiment of the present invention.

In FIG. 3, a light-scattering/reflecting substrate 10 is comprised of a substrate 20 made of a soda lime glass or an alkali-free glass, a photosensitive layer 30 that is patterned through a photolithography method and has an undulating surface, and a reflecting film 40 that is deposited on the patterned photosensitive layer 30. The photosensitive layer 30 and the reflecting film 40 constitute a light-scattering/reflecting film 50, and this light-scattering/reflecting film 50 has a function of diffusely reflecting light due to the undulating shape of the surface. A plurality of inorganic fine particles 60 made of an inorganic material are dispersed in the photosensitive layer 30, and the surface is formed into the undulating shape through these inorganic fine particles 60.

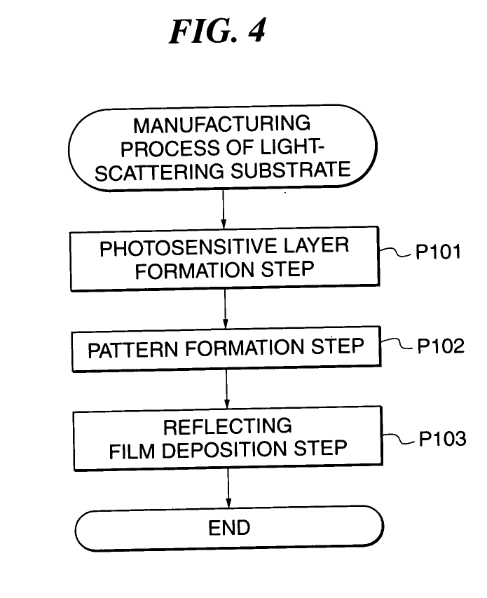

FIG. 4 is a flowchart of a manufacturing process of the light-scattering/reflecting substrate 10 appearing in FIG. 3.

(I) Photosensitive Layer Formation Step (Step P101)

First, the photosensitive layer 30 is formed on a surface of the substrate 20. At this time, to improve the adhesion to the photosensitive layer 30, the substrate 20 may be subjected to surface treatment in advance. In such surface treatment, hexamethyldisilazane or a silane coupling agent can be used.

The photosensitive layer 30 is made of a photosensitive resin composition as described below, and is formed on the substrate 20 using a commonly-used coating method, for example a spin coating method, a dipping method, a casting method, a roll coating method or the like. In the case that a solvent is contained in the photosensitive resin composition, the solvent is removed by drying if necessary. There are no particular limitations on the thickness of the coated photosensitive layer 30; this thickness can be selected from a range of, for example, 0.5 to 5 μm, preferably 0.7 to 2 μm, and is generally approximately 0.7 to 1.5 μm.

The above photosensitive resin composition is constituted from the following photosensitive resin and inorganic fine particles 60.

1) Photosensitive Resin

The photosensitive resin in the photosensitive layer 30 in the present embodiment contains a base resin (oligomer or polymer) and a photosensitizer as described below.

i) Base Resin

Examples of base resins are polar-group-containing polymers, for example hydroxy-group-containing polymers (polyvinyl alcohol, ethylene-vinyl alcohol copolymers, hydroxyl-group-containing cellulose derivatives (hydroxyethylcellulose, etc.), polyvinylphenol type resins, novolac resins (phenol novolac resins, etc.)), and carboxyl-group-containing polymers (homopolymers or copolymers containing polymerizable unsaturated carboxylic acids ((meth)acrylic acid, maleic anhydride, itaconic acid, etc.), carboxyl-group-containing cellulose derivatives (carboxymethylcellulose and salts thereof, etc.). These base resins may be used alone, or two or more may be used in combination.

Of the above, it is particularly suitable to use a polyvinylphenol type resin (a homopolymer or copolymer of vinylphenol, etc.) in which hydrophilic groups (hydroxyl groups and/or carboxyl groups, etc.) have been protected with detachable protecting groups.

Such a resin in which hydrophilic groups protected with detachable protecting groups are produced may be obtained by polymerizing a monomer in which hydrophilic groups have been protected with protecting groups in advance, or may be obtained by polymerizing a monomer having hydrophilic groups, and then protecting the hydrophilic groups of the resin obtained with the protecting groups.

Examples of the protecting groups for the hydrophilic groups include, for example, protecting groups for hydroxyl groups such as alkoxyalkyl groups, alkoxycarbonyl groups, cycloalkyl groups, oxacycloalkyl groups, and crosslinking cyclic aliphatic groups, and protecting groups for carboxyl groups such as alkyl groups. Of these, it is particularly suitable to use alkoxyalkyl groups and/or alkoxycarbonyl groups.

Representative examples of the resin include, for example, polyvinylphenol type resins in which hydroxyl groups have been protected with protecting groups such as alkoxyalkyl groups and/or alkoxycarbonyl groups (tertiary-butoxycarbonyl groups (t-BOC groups)).

ii) Photosensitizer

As the photosensitizer, a commonly-used photosensitizer, for example a diazonium salt, a diazoquinone salt, a photoacid generator or the like, can be selected.

Of the above, a photoacid generator can be suitably used in combination with a polyvinylphenol type resin that has been protected with protecting groups as described above.

Examples of photoacid generators include sulfonium salt derivatives (sulfonic acid esters (aryl-alkane sulfonates such as 1,2,3-tri(methylsulfoxy)benzene (in particular C₅˜C₁₀-aryl-C₁˜C₂-alkane sulfonates), aryl-benzene sulfonates such as 2,6-dinitrobenzyl-toluene sulfonate and benzoin tosylate (in particular, C₅˜C₁₀-aryl-toluene sulfonates, optionally having a benzoyl group), aralkyl-benzene sulfonates such as 2-benzoyl-2-hydroxy-2-phenylethyl-toluene sulfonate (in particular, C₅˜C₁₀-aryl-C₁˜C₄-alkyl-toluene sulfonates, optionally having a benzoyl group), disulfonic acids such as diphenyl disulfone, Lewis acid salts (trialryl sulfonium salts such as triphenylsulfonium hexafluorophosphate, triphenylsulfonium hexafluoroantimonate and triphenylsulfonium methanesulfonyl (in particular, triphenylsulfonium salts, etc.), etc.)), phosphonium salt derivatives, diarylhalonium salt derivatives (Lewis acid salts such as diaryliodonium salts (diphenyliodonium hexafluorophosphate, etc.), etc.), diazonium salt derivatives (Lewis acid salts such as p-nitrophenyldiazonium hexafluorophosphate, etc.), diazomethane derivatives, and triazine derivatives. In particular, a Lewis acid salt (a Lewis acid salt such as a phosphonium salt) is preferable.

The amount used of the photosensitizer can be selected, for example, from a range of approximately 0.1 to 50 parts by weight, more preferably 1 to 30 parts by weight, yet more preferably 1 to 20 parts by weight (especially 1 to 10 parts by weight), per 100 parts by weight of the base resin.

2) Inorganic Fine Particles

As the inorganic fine particles 60, for example a simple metal (gold, silver, copper, platinum, aluminum, etc.), an inorganic oxide, an inorganic carbonate, an inorganic sulfate, a phosphate or the like can be used. Examples of inorganic oxides are silica (colloidal silica, Aerosil, glass, etc.), alumina, titania, zirconia, zinc oxide, lead oxide, yttrium oxide, magnesium oxide, and the like; examples of carbonates are calcium carbonate, magnesium carbonate, and the like; examples of sulfates are barium sulfate, calcium sulfate, and so on. Examples of phosphates are calcium phosphate, magnesium phosphate, and the like. The inorganic fine particles 60 may also be, for example, a sol or gel prepared using a sol-gel method or the like.

The above types of inorganic fine particles 60 can each be used alone or two or more types can be used mixed together. The shape of the fine particles 60 is not limited to being spherical, but rather the inorganic fine particles 60 may be also be oval, flat, rod-shaped or fiber-shaped.

From the standpoint of the scattering characteristics of the light-scattering/reflecting substrate 10, it is preferable for the mean particle diameter of the inorganic fine particles 60 to be less than the exposed light wavelength, i.e. for the inorganic fine particles 60 to be substantially transparent at the exposed light wavelength. Consequently, as the mean particle diameter of the inorganic fine particles 60 , for example the mean particle diameter according to the BET method is selected from a range of approximately 1 to looonm, generally approximately 2 to 500 nm. As the fine particles, it is advantageous to use inorganic fine particles (especially colloidal silica, etc.) having a mean particle diameter according to the BET method of approximately 1 to 1000 nm, especially 2 to 500 nm (preferably 5 to 50 nm, more preferably 7 to 30 nm). Such colloidal silica is marketed as an organosol (organo-silica sol).

The proportion of the inorganic fine particles 60 in the photosensitive resin composition of the present invention can be selected from a range in which the sensitivity, the pattern resolution and so on are not impaired, and is generally not less than 100 parts by weight per 100 parts by weight of the photosensitive resin in terms of solids (i.e. not including components (solvent, water of condensation, etc.) that are produced upon heating). It is undesirable for there to be not more than 100 parts by weight of the inorganic fine particles 60 , since in such a case the adhesion to the reflecting film 4, which is an effect of the present invention, will drop. Moreover, the upper limit of the amount of the inorganic fine particles 60 should be an amount such that formation of a film of the photosensitive resin composition is possible (e.g. generally not more than 5000 parts by weight). A suitable proportion of the inorganic fine particles 60 is 100 to 5000 parts by weight, preferably 200 to 3000 parts by weight, per 100 parts by weight of the photosensitive resin.

Various additives, for example stabilizers such as antioxidants, plasticizers, surfactants, adhesion improving agents, and dissolution promoting agents, may be added to the photosensitive resin composition of the present invention as required. Furthermore, the photosensitive resin composition may contain a solvent to improve the usability, for example the ease of application. Examples of solvents are water, and organic solvents such as alcohols, glycols, cellosolves, ketones, esters, ethers, amides, and hydrocarbons; these can be used alone, or two or more can be used mixed together.

The photosensitive resin composition of the present invention can be prepared by a commonly-used method, for example by mixing together the photosensitive resin, the inorganic fine particles 60 and if necessary other components. The photosensitive resin composition generally contains a solvent. The various components may all be mixed together simultaneously, or may be mixed in a suitable order.

(II) Pattern Formation Step (Step P102)

In this step, a pattern having an undulating shape is formed on the photosensitive layer 30 using a commonly-used photolithography method in which patternwise exposure and developing are combined.

The patternwise exposure can be carried out, for example, by exposing with light or irradiating with rays via a predetermined mask. As the rays, various rays (e.g. a halogen lamp, a high-pressure mercury lamp, a UV lamp, an excimer laser, an electron beam, or radiation such as X-rays) can be used in accordance with the photosensitive characteristics of the photosensitive resin composition constituting the photosensitive layer 30, the fineness of the pattern, and so on; in general rays of wavelength approximately 100 to 500 nm, in particular ultraviolet rays, far ultraviolet rays or the like, can be used. The exposure energy can be selected in accordance with the photosensitive characteristics of the photosensitive resin composition, and in general is selected from a range of 0.01 to 10 J/cm².

In the developing that is subsequently carried out, any of various developing liquids (water, an alkaline aqueous solution, an organic solvent, or a mixture thereof) can be used in accordance with the type of the photosensitive resin composition. A preferable developing liquid is water or an alkaline aqueous solution, and if necessary a small amount of an organic solvent (e.g. an alcohol such as methanol, ethanol or isopropanol, or a ketone such as acetone), a surfactant or the like may be included. There are no particular limitations on the developing method; for example, a puddle (meniscus) method, a dipping method, a spraying method or the like can be used.

Furthermore, solvent removal and curing treatment may be carried out on the photosensitive composition by heating the applied film (the photosensitive layer 30) at a suitable temperature during a suitable step out of the steps from the application of the photosensitive resin composition up to the pattern formation. For example, if necessary heating may be carried out after the exposure with light and before the developing.

(III) Reflecting Film Deposition Step (Step P103)

Next, the reflecting film 40 is formed on the patterned photosensitive layer 30. The reflecting film 40 in the present embodiment is a thin metal film made of Al, Ag or the like, but there is no limitation thereto, and the reflecting film 40 may also be made of an Al alloy such as Al—Ti or Al—Nd, an Ag—Pd alloy, or the like. Moreover, the reflecting film 40 may be a thin film made of an inorganic material such as a dielectric substance. As the method of forming the reflecting film 40, in general a known vacuum deposition method, ion plating method, or sputtering method is used; however, so long as problems do not occur with the light-scattering/reflecting substrate 10 with regard to scattering performance, coloration and so on when the substrate temperature condition is made to be 300° C., another method may be used.

According to the light-scattering/reflecting substrate 10 of the embodiment of the present invention, the heat resistance of the patterned photosensitive layer 30 is high, and hence good adhesion can be obtained, with the reflecting film 40 not peeling off from the photosensitive layer 30 even when a cross-cut peeling test is carried out.

In the above embodiment, to form the undulating shape more precisely, it is possible to apply an inorganic material having minute spherical inorganic fine particles 60 included therein onto the glass substrate 20, and then carry out baking while causing a die having a desired shape to be in close contact with the surface on which the inorganic material has been applied, thus transferring the desired undulating shape.

A concrete description of examples of the present invention will now be given.

### EXAMPLE 1

Using colloidal silica (a PGMEA-silica sol made by Nissan Chemical Industries, Ltd.) as an inorganic component, and a polyvinylphenol type resist (AZ-DX5400P made by Clariant Corporation) as a binder, a light-scattering film 3 was manufactured using a photolithography method.

Specifically, an application liquid made by mixing together 7.5 g of colloidal silica (30 wt % solution) and 2 g of resist solution (solvent) was coated (thickness: 1 μm) onto a soda lime silicate glass substrate 2, and then the light-scattering film 3 was manufactured using a photolithography method comprised of the steps of drying off the solvent (heat treatment at 90° C. for 30 sec), exposing with light (exposure with light at 1000 mJ/cm² using a photomask), sensitizing (heat treatment at 90° C. for 30 sec to improve the contrast of a display screen obtained through the undulating surface of the light-scattering film 3), developing (10 sec of developing using PDA523AD (made by JSR)), rinsing (showering with pure water), drying, and fixing (heat treatment at 200° C. for 30 min). A reflecting film 4 made of aluminum was then deposited onto the light-scattering film 3 using a vacuum deposition method, thus manufacturing a light-scattering/reflecting substrate 1, and then the adhesion thereof was evaluated using a cross-cut peeling test (JIS K5400 3.5). The evaluation results are shown in Table 1 as the number of portions for which peeling did not occur out of 100 portions formed by segmenting with cross cuts into an array of 1 mm×1 mm squares.

TABLE 1

| | Adhesion |
|---|---|
| Example 1 | 100/100 |
| Example 2 | 100/100 |
| Example 3 | 100/100 |
| Comparative Example 1 | 60/100 |

As shown in Table 1, for Example 1 the adhesion between the light-scattering film 3 and the reflecting film 4 was 100/100, i.e. good adhesion was obtained. Moreover, upon drying off the solvent in the application liquid and taking measurements by absorption spectroscopy, the proportion of the inorganic component was 88%.

### EXAMPLE 2

Using silica powder (e.g. Aerosil) as an inorganic component, and a transparent thermosetting (or photo-curing) resin (e.g. an epoxy resin) as a binder, a light-scattering film 3 was manufactured using the following method.

An application liquid made by mixing together 8.5 g of Aerosil and 1.5 g of a catalytic curing type one-liquid epoxy resin was coated onto a glass substrate 2, then a die having the inverse of a desired undulating shape thereon was pushed against the coated surface side, and heating was carried out (or light was irradiated from the glass surface) to cure the epoxy resin, and then the die was taken away and cooling was carried out, thus manufacturing a light-scattering film 3 having the desired undulating shape transferred thereon. A reflecting film 4 made of aluminum was then deposited onto the light-scattering film 3 using a vacuum deposition method, thus manufacturing a light-scattering/reflecting substrate 1; upon measuring the adhesion thereof using the cross-cut peeling test mentioned above, good adhesion (100/100) was exhibited as shown in Table 1. Upon taking measurements on the application liquid by absorption spectroscopy, the proportion of the inorganic component was 85%.

### EXAMPLE 3

Using silica powder (e.g. Aerosil) as an inorganic component, and a metal alkoxide (e.g. tetraethoxysilane: TEOS) as a binder, a light-scattering film 3 was manufactured using the following method.

6 g of Aerosil and 20.8 g of TEOS were dispersed in a mixed solvent of 86 g of ethanol and 7.2 g of pure water, thus hydrolyzing the TEOS, and then the hydrolyzed solution was coated onto a glass substrate 2, and drying and baking steps were carried out, thus manufacturing the light-scattering film 3. A reflecting film 4 made of aluminum was deposited onto the light-scattering film 3 using a vacuum deposition method, thus manufacturing a light-scattering/reflecting substrate 1; upon measuring the adhesion thereof using the cross-cut peeling test mentioned above, good adhesion (100/100) was exhibited as shown in Table 1.

### Comparative Example 1

A light-scattering film 3 was manufactured using an organic resin (e.g. an acrylic type resin) using the same method as in Example 1, and then a reflecting film 4 made of aluminum was deposited onto the light-scattering film 3 using a sputtering method, thus manufacturing a light-scattering/reflecting substrate EXAMPLE; upon measuring the adhesion thereof using the cross-cut peeling test mentioned above, partial peeling (60/100) was exhibited as shown in Table 1.

### EXAMPLE 4

### Preparation of Photosensitive Resin Composition

(1) Photosensitive Resin

0.3 parts by weight of triphenylsulfonium hexafluorophosphate as a photoacid generator was added to 10 parts by weight of a polyvinylphenol resin having a weight average molecular weight of 8400 and having had 35 mol % of the hydroxyl groups substituted with tertiary-butoxycarbonyloxy groups; 60 parts by weight of propylene glycol monomethyl ether acetate as a solvent was then mixed in, thus preparing the photosensitive resin.

(2) Inorganic fine particles

As the inorganic fine particles 60 an organo-silica sol (made by Nissan Chemical Industries, Ltd., trade name Snowtex Colloidal Silica, PGMEA-silica sol, colloidal silica solution having 30 wt % solids with propylene glycol monomethyl ether acetate as solvent, mean particle diameter 10 to 20 nm) was used.

(3) Preparation of Photosensitive Resin Composition

The inorganic fine particles 60 obtained in (2) above were mixed in each of the proportions shown in Table 2 into 100 parts by weight of the photosensitive resin obtained in (1) above, the proportion being in terms of solids (the solid content excluding the solvent), thus preparing various photosensitive resin composition samples.

TABLE 2

| | Composition of Photosensitive | | | | | |
|---|---|---|---|---|---|---|
| | Resin Composition | | | | | |
| | (in Terms of Solids) | | Evaluation Results | | | |
| | Photosensitive | Colloidal | Pattern | Light-Scattering | Heat | |
| | Resin | Silica | Formation | Characteristics | Resistance | Adhesion |
| Example | | | | | | |
| 4 | 100 | 1567 | ◯ | ◯ | 300° C. | 100/100 |
| 5 | 100 | 733 | ◯ | ◯ | 300° C. | 100/100 |
| 6 | 100 | 317 | ◯ | ◯ | 300° C. | 100/100 |
| Comparative | | | | | | |
| Example | | | | | | |
| 2 | 100 | 0 | ◯ | ◯ | 230° C. | 60/100 |
| 3 | 100 | 80 | ◯ | ◯ | 300° C. | 80/100 |

Substrate

Each of the above photosensitive resin compositions was applied onto a surface of a washed glass substrate 20 using a spin coater such that the film thickness after drying would be 1.0 μm, and heating was carried out for 30 seconds at 90° C. on a hot plate, thus forming a photosensitive layer 30.

Next, a 248 nm interference filter was mounted on an M-2L mask aligner made by Mikasa Ltd. having a 250W low-pressure mercury lamp, and exposure with light was carried out for 100 seconds via this filter and a mask having a dot pattern. At this time, the spacing between the mask and the surface of the photosensitive resin composition was maintained at 60 μm.

After that, heating was carried out for 30 seconds at 90° C. on a hot plate, and then developing was carried out by dipping into a 1.59 wt % tetramethylammonium hydroxide aqueous solution for 10 seconds, thus forming a pattern on the photosensitive layer 30.

The patterned photosensitive layer 30 was rinsed with ion exchange water, and then heating was carried out for 30 minutes in a clean oven that had been preset to 200° C., thus carrying out solvent removal and curing treatment on the photosensitive composition.

Next, a reflecting film 40 made of an Al thin metal film was deposited on the photosensitive layer using a vacuum deposition method with a substrate temperature condition of 300° C.; various light-scattering/reflecting substrates 10 to be used as samples were thus manufactured.

Evaluation Method

The reflecting film 40 of each of the manufactured light-scattering/reflecting substrates 10 was evaluated through the pattern shape, the light-scattering characteristics, the heat resistance, and the adhesion (cross-cut peeling test (JIS K5400 3.5)).

In Example 4, a photosensitive resin composition was prepared with mixing being carried out such that the proportion of the inorganic fine particles 60 obtained in (2) above was 1567 parts by weight per 100 parts by weight of the photosensitive resin obtained in (1) above in terms of solids, and a light-scattering/reflecting substrate 10 to be used as a sample was manufactured. The results were that there were absolutely no problems regarding the pattern shape, the light-scattering characteristics, and the heat resistance, and moreover the adhesion was excellent, and peeling off of the reflecting film 40 from the light-scattering/reflecting substrate 10 was not observed.

### EXAMPLE 5

A photosensitive resin composition was prepared with mixing being carried out such that the proportion of the inorganic fine particles 60 obtained in (2) in Example 4 was 733 parts by weight per 100 parts by weight of the photosensitive resin obtained in (1) in Example 4 in terms of solids, and a light-scattering/reflecting substrate 10 to be used as a sample was manufactured. The results were that, as in Example 4, there were absolutely no problems regarding the pattern shape, the light-scattering characteristics, and the heat resistance, and moreover the adhesion was excellent, and peeling off of the reflecting film 40 from the light-scattering/reflecting substrate 10 was not observed.

### EXAMPLE 6

A photosensitive resin composition was prepared with mixing being carried out such that the proportion of the inorganic fine particles 60 obtained in (2) in Example 4 was 317 parts by weight per 100 parts by weight of the photosensitive resin obtained in (1) in Example 4 in terms of solids, and a light-scattering/reflecting substrate 10 to be used as a sample was manufactured. The results were that in Example 6 as well, as in Example 4, there were absolutely no problems regarding the pattern shape, the light-scattering characteristics, and the heat resistance, and moreover the adhesion was excellent, and peeling off of the reflecting film 40 from the light-scattering/reflecting substrate 10 was not observed.

### Comparative Example 2

A photosensitive resin composition was prepared containing absolutely none of the inorganic fine particles 60 obtained in (2) in Example 4 per 100 parts by weight of the photosensitive resin obtained in (1) in Example 4 in terms of solids, and a light-scattering/reflecting substrate 10 to be used as a sample was manufactured. The results were that that the heat resistance was low at 230° C., and hence the adhesion between the photosensitive layer 30 and the reflecting film 40 was poor at 60/100, and peeling off of the reflecting film 40 was observed.

### Comparative Example 3

A photosensitive resin composition was adjusted with mixing being carried out such that the proportion of the inorganic fine particles 60 obtained in (2) in Example 4 was 80 parts by weight per 100 parts by weight of the photosensitive resin obtained in (1) in Example 4 in terms of solids, and a light-scattering/reflecting substrate 10 to be used as a sample was manufactured. The results were that there was no problem regarding the heat resistance, but the adhesion between the photosensitive layer 30 and the reflecting film 40 was poor at 80/100, and peeling off of the reflecting film 40 was observed.

From the results for Comparative Examples 2 and 3 above, it was shown that in the case that the mixing is carried out such that the proportion of the inorganic fine particles 60 obtained in (2) in Example 4 is 80 parts by weight or less per 100 parts by weight of the photosensitive resin obtained in (1) in Example 4 in terms of solids, the heat resistance and/or the adhesion becomes poor.

The results for Examples 4 to 6 and Comparative Examples 2 and 3 described above are shown in Table 2.

From the results for Examples 4 to 6 above, in the case that the mixing was carried out such that the proportion of the inorganic fine particles 60 obtained in (2) in Example 4 was 100 parts by weight or more per 100 parts by weight of the photosensitive resin obtained in (1) in Example 4 in terms of solids, a light-scattering/reflecting substrate 10 was obtained that is good in terms of not only the pattern shape and the light-scattering characteristics, but also the heat resistance and the adhesion.

### INDUSTRIAL APPLICABILITY

As described in detail above, according to the light-scattering/reflecting substrate according to the first aspect of the present invention, the light-scattering film has an inorganic material as a principal component thereof; as a result, adhesion between the light-scattering film and the reflecting film can be improved, and durability and chemical resistance can be improved.

Moreover, the inorganic material is made of a metal oxide; as a result, adhesion between the light-scattering film and the reflecting film can be further improved.

According to the manufacturing method according to the second aspect of the present invention, the light-scattering film has an inorganic material as a principal component thereof, and in the light-scattering film formation step, the light-scattering film is formed into a desired undulating shape through a photolithography method; as a result, adhesion between the light-scattering film and the reflecting film can be improved, and durability and chemical resistance can be improved, and in addition the light-scattering film can easily be formed into the undulating shape.

According to the manufacturing method according to the third aspect of the present invention, the light-scattering film has an inorganic material as a principal component thereof, and in the light-scattering film formation step, the light-scattering film is formed into a desired undulating shape through a transfer method using a die; as a result, adhesion between the light-scattering film and the reflecting film can be improved, and durability and chemical resistance can be improved, and in addition the light-scattering film can easily be formed into the undulating shape.

According to the manufacturing method according to the fourth aspect of the present invention, the light-scattering film has an inorganic material as a principal component thereof, and in the light-scattering film formation step, the light-scattering film is formed into a desired undulating shape by including fine particles inside the light-scattering film; as a result, adhesion between the light-scattering film and the reflecting film can be improved, and durability and chemical resistance can be improved, and in addition the light-scattering film can easily be formed into the undulating shape.

Moreover, the fine particles are made of an inorganic material; as a result, the effects of the manufacturing method according to the fourth aspect of the present invention can be produced reliably.

According to the photosensitive resin composition for light-scattering/reflecting substrates according to the fifth aspect of the present invention, the photosensitive resin composition is constituted from a photosensitive resin and inorganic fine particles; as a result, heat resistance can be increased, and adhesion of a reflecting film can be improved.

Moreover, the inorganic fine particles have a mean particle diameter in a range of 1 to 100 nm; as a result, this mean particle diameter is less than an exposed light wavelength, i.e. the inorganic fine particles can reliably be made to be substantially transparent at the exposed light wavelength, and hence good light-scattering characteristics can be obtained.

Moreover, the inorganic fine particles are colloidal silica; as a result, inorganic fine particles having a mean particle diameter enabling good light-scattering characteristics to be obtained can easily be procured.

Moreover, if the photosensitive resin composition can be developed using water or an alkaline aqueous solution, then heat resistance can be increased reliably, and adhesion of a reflecting film can be improved reliably.

Furthermore, the photosensitive resin contains a polyvinylphenol type resin having hydroxyl groups protected by at least one of alkoxyalkyl groups and alkoxycarbonyl groups, and a photoacid generator; as a result, the photosensitive resin composition for light-scattering/reflecting substrates can reliably be made to be able to be developed using water or an alkaline aqueous solution.

Moreover, the proportion of the inorganic fine particles is in a range of 100 to 5000 parts by weight per 100 parts by weight of the photosensitive resin in terms of solids; as a result, there is no impairment of sensitivity or pattern resolution. Moreover, in the case that there is less than 100 parts by weight of the inorganic fine particles, adhesion of a reflecting film, which is an effect of the present invention, drops, and in the case that there is more than 5000 parts by weight of the inorganic fine particles, it becomes impossible to form a film of the photosensitive resin composition; consequently, when the proportion of the inorganic fine particles is in a range of 100 to 5000 parts by weight in terms of solids, film formation can be carried out, without causing a drop in adhesion of a reflecting film.

Moreover, the proportion of the inorganic fine particles is in a range of 200 to 3000 parts by weight per 100 parts by weight of the photosensitive resin in terms of solids; as a result, there is no impairment of sensitivity or pattern resolution, and moreover film formation can be carried out reliably, without causing a drop in adhesion of a reflecting film.

According to the light-scattering/reflecting substrate according to the sixth aspect of the present invention, a photosensitive layer made of the photosensitive resin composition according to the fifth aspect of the present invention is formed on a substrate; as a result, heat resistance can be increased, and adhesion of a reflecting film can be improved.

According to the manufacturing method according to the seventh aspect of the present invention, a photosensitive layer made of the photosensitive resin composition according to the fifth aspect of the present invention is formed on a substrate; as a result, heat resistance can be increased, and adhesion of a reflecting film can be improved.

1. A light-scattering/reflecting substrate, comprising:
a substrate;
a light-scattering film having an undulating shape and formed on said substrate; and
a reflecting film formed on said light-scattering film;
the light-scattering/reflecting substrate being characterized in that said light-scattering film has an inorganic material as a principal component thereof.

2. A light-scattering/reflecting substrate as claimed in claim 1, characterized in that the inorganic material is made of a metal oxide.

3. A method of manufacturing a light-scattering/reflecting substrate, comprising:
a light-scattering film formation step of forming a light-scattering film on a substrate; and
a reflecting film formation step of forming a reflecting film on the light-scattering film;
the method being characterized in that the light-scattering film has an inorganic material as a principal component thereof, and in said light-scattering film formation step, the light-scattering film is formed into a desired undulating shape through a photolithography method.

4. A method of manufacturing a light-scattering/reflecting substrate, comprising:
a light-scattering film formation step of forming a light-scattering film on a substrate; and
a reflecting film formation step of forming a reflecting film on the light-scattering film;
the method being characterized in that the light-scattering film has an inorganic material as a principal component thereof, and in said light-scattering film formation step, the light-scattering film is formed into a desired undulating shape through a transfer method using a die.

5. A method of manufacturing a light-scattering/reflecting substrate, comprising:
a light-scattering film formation step of forming a light-scattering film on a substrate; and
a reflecting film formation step of forming a reflecting film on the light-scattering film;
the method of manufacturing a light-scattering/reflecting substrate characterized in that the light-scattering film has an inorganic material as a principal component thereof, and in said light-scattering film formation step, the light-scattering film is formed into a desired undulating shape by including fine particles inside the light-scattering film.

6. A method of manufacturing a light-scattering/reflecting substrate as claimed in claim 5, characterized in that the fine particles are made of an inorganic material.

7. A photosensitive resin composition for light-scattering/reflecting substrates, characterized by comprising:
a photosensitive resin; and
inorganic fine particles.

8. A photosensitive resin composition for light-scattering/reflecting substrates as claimed in claim 7, characterized in that said inorganic fine particles have a mean particle diameter in a range of 1 to 100 nm.

9. A photosensitive resin composition for light-scattering/reflecting substrates as claimed in claim 8, characterized in that said inorganic fine particles are colloidal silica.

10. A photosensitive resin composition for light-scattering/reflecting substrates as claimed in any one of claims 7 through 9, characterized by being able to be developed using water or an alkaline aqueous solution.

11. A photosensitive resin composition for light-scattering/reflecting substrates as claimed in claim 10, characterized in that said photosensitive resin contains a polyvinylphenol type resin having hydroxyl groups protected by at least one of alkoxyalkyl groups and alkoxycarbonyl groups, and a photoacid generator.

12. A photosensitive resin composition for light-scattering/reflecting substrates as claimed in any one of claims 7 through 11, characterized in that a proportion of said inorganic fine particles is in a range of 100 to 5000 parts by weight per 100 parts by weight of said photosensitive resin in terms of solids.

13. A photosensitive resin composition for light-scattering/reflecting substrates as claimed in claim 12, characterized in that the proportion of said inorganic fine particles is in a range of 200 to 3000 parts by weight per 100 parts by weight of said photosensitive resin in terms of solids.

14. A light-scattering/reflecting substrate, characterized by comprising a substrate, and a photosensitive layer made of a photosensitive resin composition as claimed in any one of claims 7 through 13 formed on said substrate.

15. A method of manufacturing a light-scattering/reflecting substrate, characterized by forming a photosensitive layer made of a photosensitive resin composition as claimed in any one of claims 7 through 13 on a substrate.
